(19) United States
(12) Patent Application Publication
(10) Pub. No.: US 2025/0389690 A1
(43) Pub. Date: Dec. 25, 2025

(54) MAN-TO-MACHINE INTERFACE TOWARD AUTOMATED ELECTROCHEMISTRY EXPERIMENTS

(71) Applicant: University of Kentucky Research Foundation, Lexington, KY (US)

(72) Inventors: Siamak Mahmoudi, Lexington, KY (US); Asmund Vego, Lexington, KY (US); Rebekah Duke, Lexington, KY (US); Aman Prett Kaur, Lexington, KY (US); David Eaton, Lexington, KY (US); Chad Risko, Lexington, KY (US)

(21) Appl. No.: 19/244,910

(22) Filed: Jun. 20, 2025

Related U.S. Application Data
(60) Provisional application No. 63/662,253, filed on Jun. 20, 2024.

(51) Int. Cl. G01N 27/416; B25J 19/02

(52) U.S. Cl. CPC G01N 27/416; B25J 19/02

(57) ABSTRACT

This disclosure is directed to a computer-implemented method for performing automated electrochemical experimentation and for analyzing data generated by the electrochemical experimentation. The disclosure is further directed to a system including a robotic assembly configured for performing the automated electrochemical experimentation and for analyzing data generated by the electrochemical experimentation which implements the computer-implemented method.

### RELATED APPLICATIONS

This application claims priority to U.S. provisional patent application Ser. No. 63/662,253 filed on Jun. 20, 2024, the entirety of the disclosure of which is incorporated herein by reference.

### GOVERNMENT INTEREST

This invention was made with partial government support under Cooperative Agreement Number 2019574 awarded by the National Science Foundation. The government has certain rights in the invention.

### TECHNICAL FIELD

The presently disclosed subject matter generally relates to software for automated completion of experiments. In particular, the disclosure relates to software and attendant hardware for automating electrochemistry experiments requiring particular parameters, such as specific reagents, specific run parameters (time, temperature, etc.), and others, and for collecting results. The software and attendant hardware find utility in a variety of applications, including without intending any limitation cyclic voltammetry experimentation.

### BACKGROUND

Rapid advances in the availability and scale of big data in chemistry have generated exciting results.¹⁻⁴ It is hypothesized that science is entering a fourth paradigm-big-data driven science-where progress relies on the use of big-data analytics to identify subtle trends and the use of data-informed predictive models to direct exploration.⁵ The shift toward big-data driven chemistry has the potential to amplify lab productivity and escalate scientific progress much as it has done in the fields of biology and medicine.^{6,7} Already, data-driven analytic techniques ranging from data relationship mining and data clustering to anomaly detection and predictive models are accelerating research across many fields of chemistry.^{4,8} While big data approaches in chemistry have seen great success, much of these datasets are confined to computational data, which are faster and cheaper to amass.

But big data approaches are not limited to computational data. When applied to experimental data, big data approaches such as machine learning (ML) and trend analysis can be even more promising.⁸⁻¹⁰ Experimental data provide a more accurate representation of the functional world than computational data and are therefore more useful for designing materials for practical use.¹¹ However, few experimentalists have the experience and expertise to collect and store large quantities of data, let alone apply meaningful big data analysis. Additionally, experimental data are often tedious and time consuming to produce, limiting the number of data points available for big data analysis. Therefore, there is a need for more efficient collection and generation of experimental data to enable big data analysis.

The first step is collecting experimental data. Yet, collecting and curating experimental data is non-trivial. While it may be simple to extract some data from instrument-produced files, these files often lack necessary metadata. Metadata include information on materials and experimental procedures, such as what materials were used, how they were prepared, and what conditions were present during data collection. Typically, metadata are recorded in a laboratory notebook. This system of recording metadata has several problems including missing detail when only selected details are transferred to the published paper and tedious manual analysis. Additionally, the data produced in the chemist's experiments are not machine-readable. Machine-readable data are essential for the collection and curation of big data. Therefore, there is a need for methods to combine experimental data collection with systematic, machine-readable metadata. Such efforts will enable the use of big data analytics and machine learning while establishing the data management framework required to integrate robotic/autonomous experimentation into laboratories.^{10,12}

Many research efforts to capture experiment procedural data¹³⁻¹⁵ and automate chemistry experiments exist.^{9,16-18} However, little work exists to systematically capture electrochemistry procedural data and/or automate electrochemistry experiments. Yet electrochemistry, and especially cyclic voltammetry (CV), holds a crucial role in chemical research. Fields ranging from drug discovery^{19,20} to energy and materials research²¹⁻²³ to processing engineering^{24,25} to environmental chemistry²⁶ utilize CV for characterization and analysis. Thus, there is a pressing need to build software to capture electrochemical procedural data and build software and hardware to translate these data into automated experimentation.

While in some cases, it is relatively simple to extract data from instrument-produced data files, these files do not contain all the necessary metadata. Often these metadata are written in laboratory notebooks, which can result in several problems including missing details, tedious manual analysis, and data that is not machine-readable.

A central challenge in automation is translating human-derived ideas to robotic movements. The present disclosure describes an intuitive platform for chemists to encode the procedure for their electrochemical experiments. These machine-readable procedures are than translated into automated CV experiments by software and hardware infrastructure to run CV experiments. Here we describe a data sharing and reporting software that currently targets electrochemistry. To this end, we deploy a web platform that allows experimentalists to systematically encode their laboratory procedures through an intuitive graphical user interface that operates like a fill-in-the-blank lab notebook. Chemists can attach data files directly to their experimental measurements where built-in calculators derive properties such as diffusion coefficient and charge transfer rate constant. Additionally, standardized experimental workflows enable the easier translation of human-developed laboratory procedures to robotic experimentation. We demonstrate this by automating the translation of chemist-designed procedures, robotic actions, reproducing several literature reported electrochemical results. Ultimately, these tools enable automated cyclic voltammetry experiments which will facilitate data-driven discovery and experimental reproducibility in electrochemistry.

### SUMMARY

The details of one or more embodiments of the presently disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

In one aspect, this disclosure is directed to a system comprising a processor, memory, storage, and computer-readable instructions and configured for performing automated electrochemical experimentation and for analyzing data generated by said electrochemical experimentation. The system includes a Template module configured for receiving a one or more experimental inputs representing experimental parameters for one or more electrochemical experiments, The system further includes an Experiment module configured for selecting one or more experimental inputs from the plurality of experimental inputs to define at least one specific electrochemical experiment to be conducted and a number of experimental runs of the at least one specific electrochemical experiment. The Experiment module is further configured to record data generated by the at least one specific electrochemical experiment.

The system further includes a Run module configured for outputting the one or more experimental inputs to a robotics computing device comprising a processor, memory, and storage and a data parser configured to extract data from the recorded data and metadata from the defined at least one specific electrochemical experiment. A robotic assembly is provided, adapted for performing the specific electrochemical experiment.

In embodiments, the one or more experimental inputs are selected from the group consisting of reagent types, apparatus items, and workflow actions and the reagent types are selected from the group consisting of one or more of a redox molecule, a solvent, and an electrolyte solution. The apparatus items may be are one or more of glassware and/or plasticware, a working electrode, a reference electrode, an electrode counter, and an electrochemical cell.

In embodiments, the workflow actions are selected from the group consisting of liquid transfer actions, solid transfer actions, heating actions, stirring actions, measurements of the working electrode surface area, and data collection actions. The recorded data may be selected in embodiments from the group consisting of experiment times, reagent weights, temperatures, and raw data resulting from the at least one specific electrochemical experiment.

In embodiments, the robotic assembly comprises a robotic arm adapted for grasping and translating a vial, a grid vial stand, a vial elevator adapted to translate one or more vials in a substantially vertical direction, and a potentiostat. A computing device comprising a processor, memory, storage, and an interface to the robotic arm is provided, further comprising computer-readable instructions for transferring the one or more experimental inputs from the plurality of experimental inputs to define the at least one specific electrochemical experiment.

In another aspect, a computer-implemented method for performing automated electrochemical experimentation and for analyzing data generated by said electrochemical experimentation is provided. The method includes providing a Template module configured for receiving a one or more experimental inputs representing experimental parameters for one or more electrochemical experiments. An Experiment module is also provided, configured for: (1) selecting one or more experimental inputs from the plurality of experimental inputs to define at least one specific electrochemical experiment to be conducted and a number of experimental runs of the at least one specific electrochemical experiment, and (2) recording data generated by the at least one specific electrochemical experiment.

A Run module is also provided, configured for outputting the one or more experimental inputs to a robotics computing device comprising a processor, memory, and storage. In turn, a data parser is provided, configured to extract data from the recorded data and metadata from the defined at least one specific electrochemical experiment.

A robotic assembly is also provided, adapted for performing the specific electrochemical experiment, the robotic assembly comprising a computing device comprising a processor, memory, storage, and an interface to the robotic arm, further comprising computer-readable instructions for transferring the one or more experimental inputs from the plurality of experimental inputs to define the at least one specific electrochemical experiment.

In embodiments, the method includes selecting the experimental inputs from the group consisting of reagent types, apparatus items, and workflow actions. In embodiments, the method includes selecting the reagent types from the group consisting of redox molecules, solvents, and electrolyte solutions.

In embodiments, the method includes selecting the apparatus items from the group consisting of glassware and/or plasticware, a working electrode, a reference electrode, an electrode counter, and an electrochemical cell. In embodiments, the method includes selecting the workflow actions from the group consisting of liquid transfer actions, solid transfer actions, heating actions, stirring actions, measurements of the working electrode surface area, and data collection actions. In embodiments, the method includes selecting the recorded data from the group consisting of experiment times, reagent weights, temperatures, and raw data resulting from the at least one specific electrochemical experiment.

It will be understood that various details of the presently disclosed subject matter can be changed without departing from the scope of the subject matter disclosed herein. Furthermore, the foregoing description is for the purpose of illustration only, and not for the purpose of limitation.

### BRIEF DESCRIPTION OF THE DRAWINGS

The presently disclosed subject matter will be better understood, and features, aspects and advantages other than those set forth above will become apparent when consideration is given to the following detailed description thereof. Such detailed description makes reference to the following drawings, wherein:

FIG. 1 schematically illustrates a representative ExpFlow data organizational structure.

FIG. 2 schematically illustrates a representative CV experiment graph as an ExpFlow Template, Experiment, and Run.

FIG. 3 shows robotic hardware adapted for use with the disclosed ExpFlow software. Top: Overview including the robotic arm, grid vial holder and vials, potentiostat, connections and vial elevator. Bottom: Close-up view of the vial elevator with electrodes and connections.

FIG. 4 schematically illustrates a representative data cycle for translating human-conceptualized experimental procedures to robotic actions and translating resulting experimental data to human-readable information.

FIG. 5 schematically illustrates a representative data structure for robotic applications.

FIG. 6A illustrates a representative Template module workflow for robotic experimentation.

FIG. 6B illustrates use of the Template module of FIG. 6A in creating four separate experiments.

FIG. 7 shows chemical structures of electroactive molecules used in this study.

FIG. 8-15 show CV gathered for eight redox-active systems, for three trials. All redox-active species were dissolved at 0.01 M in 0.25 M TEABF₄/acetonitrile electrolyte. Voltammograms are collected at room temperature under ambient conditions and are reported using IUPAC convention. FIG. 8 shows CV data for ferrocene (Fc).

FIG. 9 shows CV for N-[2-(2-Methoxyethoxy)ethyl]-phenothiazine (MEEPT).

FIG. 10 shows CV for Dimethylphenazine (DMPZ).

FIG. 11 shows CV for 4-Methoxy-2,2,6,6-tetramethyl-1piperidinyloxy (4-MeOTEMPO).

FIG. 12 shows CV for 1,4-Di-tert-butyl-2,5-dimethoxybenzene (DBB).

FIG. 13 shows CV for 1,4-Di-tert-butyl-2,5-bis (2-methoxyethoxy) benzene (DBBB).

FIG. 14 shows CV for Thianthrene (TH).

FIG. 15 shows CV for N-Ethylcarbazole (ECZ).

FIG. 16 graphically illustrates a plot produced by embedded data processors for trial 2 of: Top: Fc (see FIG. 8); Bottom: ECZ (see FIG. 15).

FIG. 17 graphically illustrates a comparison of values produced during robotic experimentation and literature reported values for oxidation potential (top) and diffusion coefficient (bottom). Robotic experiment values are reported as the average value across the three trials where the error bars are twice the standard deviation. The line represents ideal one-to-one correlation between robotic and literature reported values. All robotic potentials are measured vs. Ag/Ag⁺. For comparison, literature reported oxidation potentials are reported referenced to Ag/Ag⁺ as except for MEEPT and DBBB. The oxidation potentials for MEEPT and DBBB are estimated relative to Fc/Fc⁺ using the potential gathered for Fc in the robotic experiments as the standard.

FIG. 18 shows a representative ExpFlow Experiment run. FIG. 19 shows a representative screenshot of processed ExpFlow data.

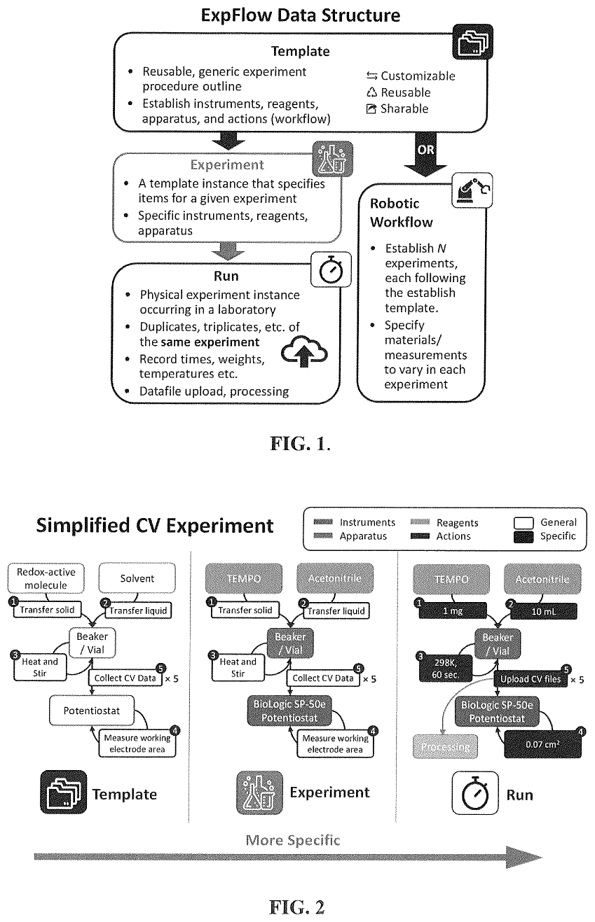

### DETAILED DESCRIPTION

The details of one or more embodiments of the presently disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clarity of understanding and no unnecessary limitations are to be understood therefrom. In case of conflict, the specification of this document, including definitions, will control.

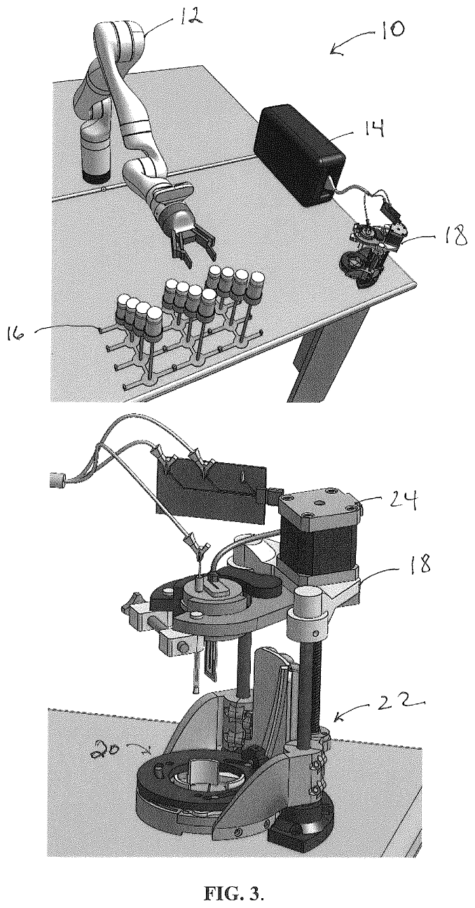

In one aspect, the present disclosure describes robotic hardware 10 infrastructure for performing electrochemistry experiments such as a cyclic voltammetry (CV) experiment from a pre-mixed solution. In the embodiment shown in FIG. 3, the robotic hardware 10 included a robotic arm 12 (Kinova³³ Gen 3) having 6 degrees of freedom, maximum reach of 89 cm, and maximum payload of 2 kg, a potentiostat 14 (BioLogic³⁴ (SP-50e)), a grid vial stand 16, and a vial elevator 18. The robotic arm 12 interfaces with a computing device (not shown) through an Ethernet port and can be integrated in a number of software environments including python. Potentiostat 14 was a single channel unit capable of interfacing with python via available APIs via a USB connection.

Grid vial stand 16 consists of 12 individual vial holders in the illustrated embodiment, designed in a way the robotic arm 12 can access each vial 18 carried by the grid vial stand without colliding with other vials. Hence, each row of vials 18 has its own unique height. The vial elevator 18 has a platform that receives the vials brought by the robotic arm. This platform rises so that the electrodes (connected to potentiostat) dip into the solution and then lowers after data are acquired. A centering mechanism also centers the vial during its rise to meet the tight precision requirement between the printed electrode and the rim of the vials. The vial elevator 18 serves two main purposes: (1) it provides the precision needed for moving the vials and (2) eliminates mechanical disturbances that would otherwise degrade the quality of the CV data. General requirements for the vial elevator 18 were:
1. Must be in “release state” at the low end of the lift travel to let the robotic arm place vials or take them.
2. Must be in the “hold state” at the top of the vertical travel.
3. Must keep the vial aligned with the electrode to avoid collisions with the electrodes.
4. Must provide enough clearance for the robotic arm to place/take vials from the holder, both in vertical and planar directions.
5. Must be able to receive commands from the controlling PC running python scripts and send confirmation messages back to it.

The vial elevator 18 mechanism consisted of two main sub-assemblies: a holder mechanism 20 and a lifting mechanism 22. The holder mechanism 20 consists of a base that attaches to the two arms of the elevator 18. There are three rotating arms that hold and center vials, which are simultaneously controlled via a rotating ring. The ring's connection to the arms is through pins (attached to the arms) and grooves (on the rotating ring). Thus, rotation of the ring translates into identical rotational motion of the three rings. The rotational motion of the ring is generated via a pin that is attached to the side of the ring. As the elevator 18 raises or lowers the holder mechanism, this pin contacts a stationary sloping surface. This contact forces the ring to rotate, which in turn moves the arms. This contact force is unidirectional in that it only forces the arms to open as the elevator lowers the holder. Closure of the arms is facilitated by springs located in the base of the holder. These springs always apply closing forces to the arms.

The moving part of the elevator attaches to the base of the holder mechanism. There are two linear motion bearings inside the moving part that ride on motion guide rods. This setup limits the degrees of freedom to one. Vertical motion is provided by a stepper motor 24 (NEMA 17) with lead screw shaft and lead screw nut that is attached to the moving part of the mechanism. The lower end and upper end of motion range are detected by two limit switches. To run the stepper motor, a stepper motor driver (model number DM542T) was used along with suitable power supply and a microcontroller board (Arduino Mega). The microcontroller establishes a serial connection with the python interface and upon receiving “up” or “down” commands, runs the stepper motor in the correct direction until corresponding limit switches are activated.

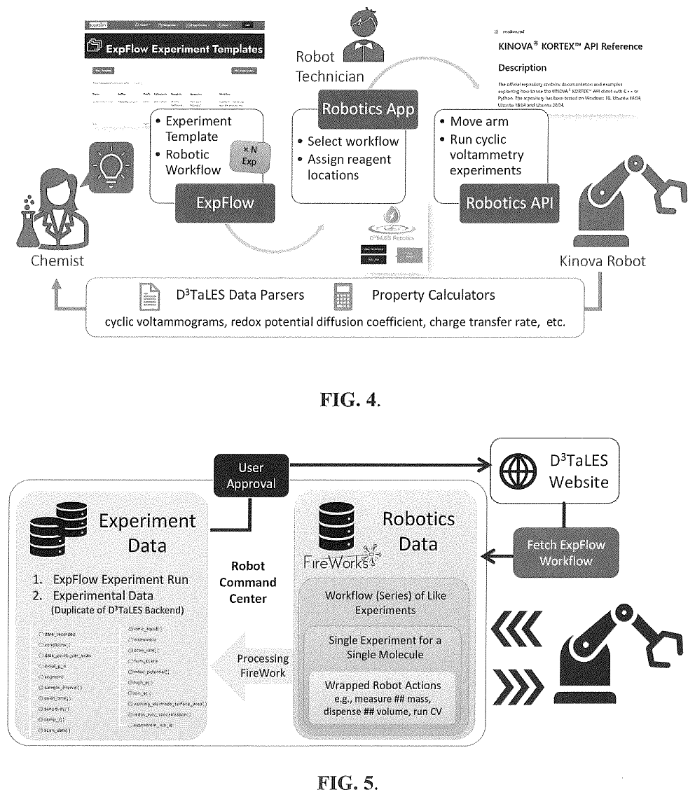

In another aspect, the present disclosure is directed to software infrastructure termed ExpFlow, configured to connect chemist-created experimental procedures to robotic actions, and to subsequently communicate collected data back to a user (see FIGS. 1 and 4). The described computer program comprises a Template module, an Experiment module, and a Run module. Once a chemist creates an ExpFlow Template and converts it into a Robotic Workflow, a robotic technician downloads the Robotic Workflow to the local robotics computer. Here, through a local robotics app we developed (see FIG. 5), the technician loads the workflow and assign reagent locations. This step requires human actions from the onsite robot technician as a safety measure to ensure that robotic experiments always have human supervision. The app software scours the workflow for reagents and prompts the robot technician to match each distinct reagent with a position on the experiment table. Finally, a robotics API translates the loaded workflow into robotic actions. The robotics API integrates the commercial Kinova API,³¹ the Fireworks workflow management python package,³² and original code. Successful experiment completion automatically triggers a data processing job. This job uses D³TaLES data parsers and property calculators (the same used in ExpFlow) to analyze and plot the resulting CV data. Where appropriate, all analyses performed by ExpFlow are performed here (Table 1).

TABLE 1
Example extracted and calculated metadata
derived by ExpFlow from CV experiments.

| Property | Description | Property Lype |
|---|---|---|
| scan_data | List of scans | CV Prop. (extracted) |
| peak_potential | Highest potential reached | CV Prop. (extracted) |
| reversibility | List of reversibility | CV Prop. (extracted) |
| | categorizations for peaks | |
| e_half | List of E_{1/2} for peaks | CV Prop. (extracted) |
| peak_splittings | List of peak splittings for peaks | CV Prop. (extracted) |
| middle_sweep | Middle sweep list | CV Prop. (extracted) |
| forward | Data points from forward scan | CV Prop. (extracted) |
| reverse | Data points from reverse scan | CV Prop. (extracted) |
| oxidation_{—} | Oxidation potential of the | Molecular Prop. |
| potential | molecule | (calculated) |
| reduction_{—} | Reduction potential of the | Molecular Prop. |
| potential | molecule | (calculated) |
| diffusion_{—} | Diffusion coefficient using | Molecular Prop. |
| coefficient | Randles-Sevcik equation, | (calculated) |
| | default cm²/s | |
| charge_{—} | Rate of charge transfer in | Molecular Prop. |
| transfer_rate | solution, default cm/s | (calculated) |

A user first builds a template that lists the reagent types, apparatus items, and workflow actions. For example, in a basic cyclic voltammetry (CV) experiment to determine diffusion coefficient, the reagents would include a redox_molecule and solvent. Likewise, the apparatus list might include a beaker, electrode_working, electrode_reference, electrode_counter, and electrochemical_cell. Then, the user must list the workflow actions for the experiment: transfer_liquid to measure solvent and transfer it to the beaker, transfer solid to measure the redox-active molecule and transfer it to the beaker, heat_stir the solution, measure_surface_area_of_working_electrode, and collect_cv_data. There may be multiple data collection actions. For example, in this example, the user might add five collect_cv_data actions because the experiment includes five CVs, each run at a different scan rate. Each action incorporates a standard action type, starting and ending positions, and a brief description. Although these templates take time and effort to produce, they can be reused for all related experiments. Additionally, any existing template can be cloned and modified, limiting the amount of time needed to construct new templates. Templates can also be shared among ExpFlow users and with the broader scientific community (e.g., through publications).

First, we constructed an ExpFlow Template for the following process: run one CV scan on a blank solvent/supporting electrolyte solution to confirm the electrodes' cleanliness, select a redox-active solution, perform one benchmark CV scan to determine the optimum voltage range, collect eight cyclic voltammograms (each at a different scan rate), and process all generated data. From this Template, we generated a Robotic Workflow for performing this experiment on the eight distinct solutions. Robotic experiments were then performed from this workflow, and the workflow was completed three times with new solutions and electrodes each time, so the experiment was run in triplicate for each electroactive system.

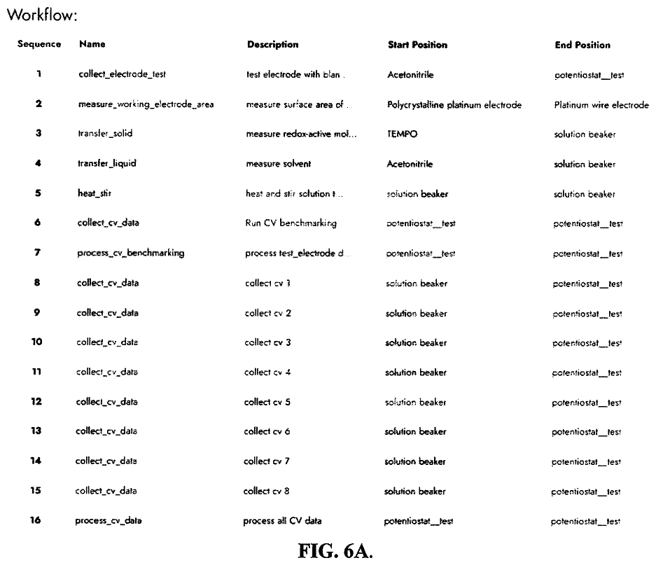

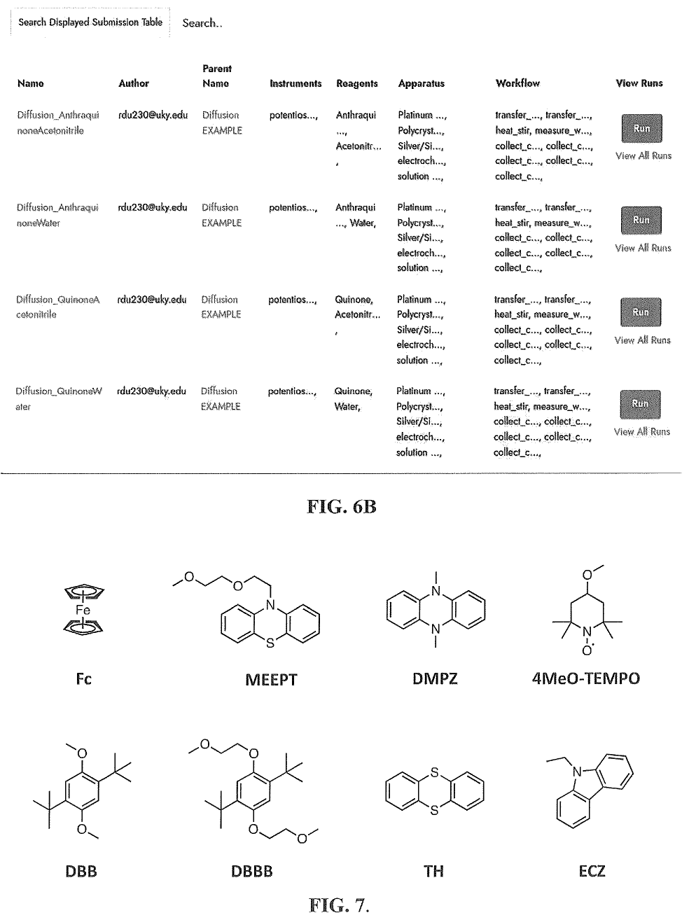

An example ExpFlow Template for use in robotic experiments is shown in FIG. 6A. The workflow first selects a vial of a blank solvent/supporting electrolyte solution and runs one CV scan at 100 m V/s to record the state of the electrodes (collect_electrode_test action, sequence 1). Then it selects the appropriate vial of redox-active molecule/solvent/supporting electrolyte solution and prepares to run the experiment CV (sequences 2-5). (Note that, while the solution preparation sequences include transfer_solid, transfer_liquid, and heat_stir actions, these are not yet implemented in our current robotic setup. The code simply selects the appropriate pre-mixed solutions and skips over these preparation actions.) The workflow then runs one CV at a pre-specified voltage interval (sequence 6), then a processing action finds the CV peaks and institutes a new voltage interval 0.3V before and after the CV peaks (process_cv_benchmark action, sequence 7). Finally, eight CV scans are run, each at a different scan rate, (sequences 8-15) and data processing is performed to plot data and determine meta properties (sequence 16).

As will be appreciated by the skilled artisan, one template can be used for many experiments with the same procedure. An experiment specifies the template reagents. For example, the template of FIG. 6A might be used to create four experiments: Two for quinone in water then in acetonitrile, and two for anthraquinone in water then in acetonitrile (see FIG. 6B).

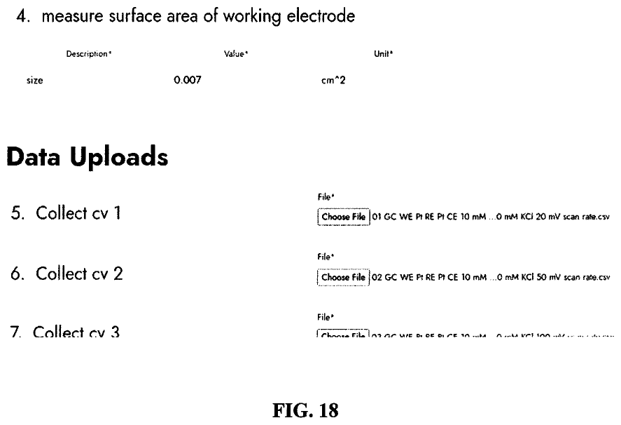

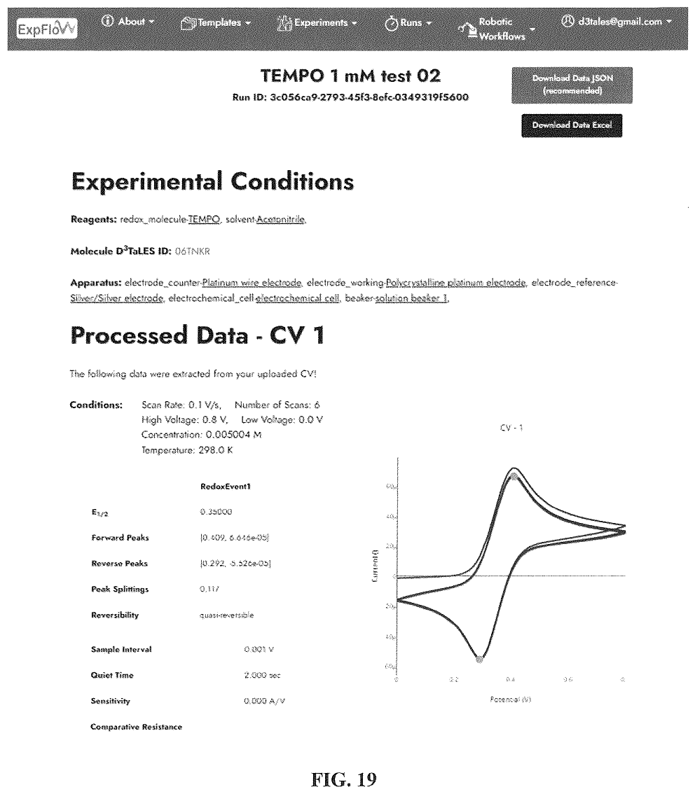

Once a user constructs an experiment, they may run that experiment any number of times. Experiment runs record specific values such as times, weights, temperature, and raw data files. Each action type (specified in the template-building step) includes a series of built-in run parameters. During an experiment run, the user is prompted to fill in each of these run parameters. For example, the transfer_liquid action type prompts the user to record the liquid's exact volume, while the heat_stir action type prompts the user to record the temperature and the time of stirring. Data collection action types such as collect_cv_data prompts the user to upload a raw data file, in this case, the potentiostat output file (see FIG. 18).

After an experiment run, ExpFlow uses the D³TaLES data parsers to extract data from the uploaded experiment files. ExpFlow also extracts key metadata from experiment run parameter data. For example, ExpFlow extracts the solution temperature from the heat stir action and it calculates the solution concentration from the transfer_solid and transfer_liquid actions. All extracted data are displayed on a user interface where the user can inspect and approve the experiment run data. This user interface also hosts the ExpFlow calculators for experiment runs with relevant data. For example, in the diffusion coefficient experiment example, the user can calculate the diffusion coefficient from a run with the push of a button (see FIG. 19).

### EXAMPLES

CV experiments for eight well-known electroactive systems³⁵⁻⁴² were performed (FIG. 7): Ferrocene (Fc), N-[2-(2-Methoxyethoxy) ethyl]-phenothiazine (MEEPT), dimethylphenazine (DMPZ), 4-Methoxy-2,2,6,6-tetramethyl-1-piperidinyloxy (4-MeOTEMPO), 1,4-Di-tert-butyl-2,5-dimethoxybenzene (DBB), 1,4-Di-tert-butyl-2,5-bis (2-methoxyethoxy) benzene (DBBB), thianthrene (TH) and N-Ethylcarbazole (ECZ). Acetonitrile (ACN, anhydrous ≥99.8%, ChemSeal) was purchased from Thermo Scientific through VWR. Tetraethylammonium tetrafluoroborate (TEABF_{4,}>99.9%, Gotion) and Silver tetrafluoroborate (AgBF_{4,}99%, Matrix Scientific), Ferrocene (Fc, 98%, Aldrich), N-[2-(2-Methoxyethoxy) ethyl]phenothiazine (MEEPT, >98%, TCI America), 5,10-Dimethyl-5,10-dihydrophenazine (DMPZ, 99%, A2B Chem LLC), 4-Methoxy-2,2,6,6-tetramethyl-1-piperidinyloxy (4MeO-TEMPO, 97%, Aldrich), 1,4-Di-tert-butyl-2,5-dimethoxybenzene (DBB, 3M), 1,4-Di-tert-butyl-2,5-bis (2-methoxyethoxy)benzene (DBBB, >99%, Strem Chemicals), Thianthrene (TH, 97%, Aldrich) and 9-Ethylcarbazole (ECZ, >99%, TCI America) were used as purchased.

The electrolyte used for CV experiments contained 0.25 M TEABF₄ in ACN. Fc, MEEPT, DMPZ, 4MeO-TEMPO, DBB, DBBB, TH and ECZ were dissolved at 10 mM in 0.25 M TEABF₄/ACN (10 mL) in screw capped scintillation glass vials. All solutions were freshly prepared for each trial. CV experiments were performed on electro-active solutions using a three-electrode system under ambient conditions. The cell is comprised of a screen-printed electrode fabricated on ceramic substrate (pine research) with a 2 mm diameter Au working electrode, and a large surface area U-shaped Au counter electrode and a Ag pseudo-reference electrode (pine research). The reference electrode was freshly prepared by immersing silver wire in a fritted tube (pine research) containing 10 mM AgBF₄ dissolved in 0.25 M TEABF₄/ACN. The electrodes were held in place using a grip mount (Pine Research) and a cell cap (Pine Research, fits scintillation vial and grip mount) and connected to potentiostat using universal specialty cell connection kit (Pine Research). The electrodes were used as received. A new screen-printed electrode and glass frit for reference electrode were used for each trial. CV experiments were performed, and data was collected using Bio Logic (SP-50e) potentiostat. The voltammograms were recorded at scan rates of 25, 50, 75, 100, 200, 300, 400 and 500 mV/s. No solution resistance compensation (iR correction) was applied.

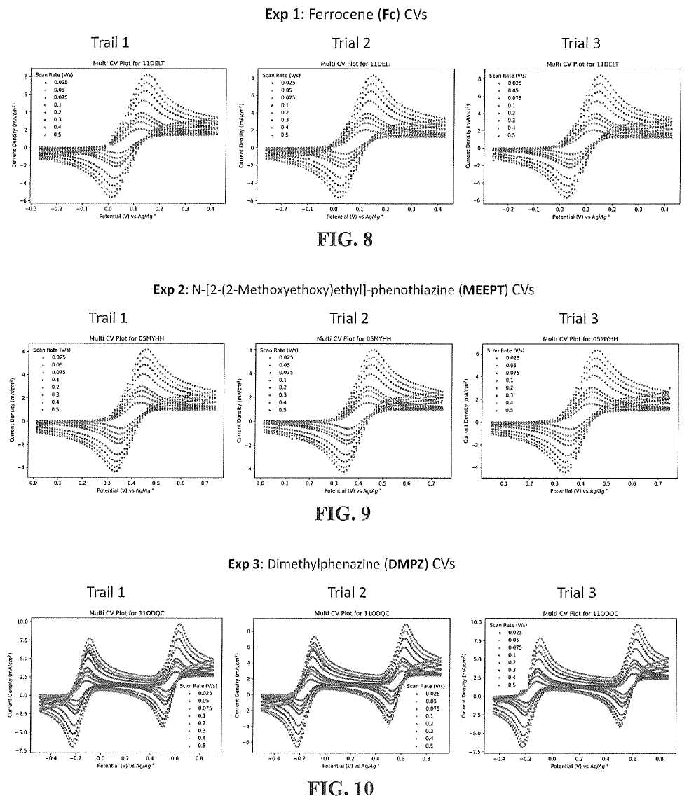

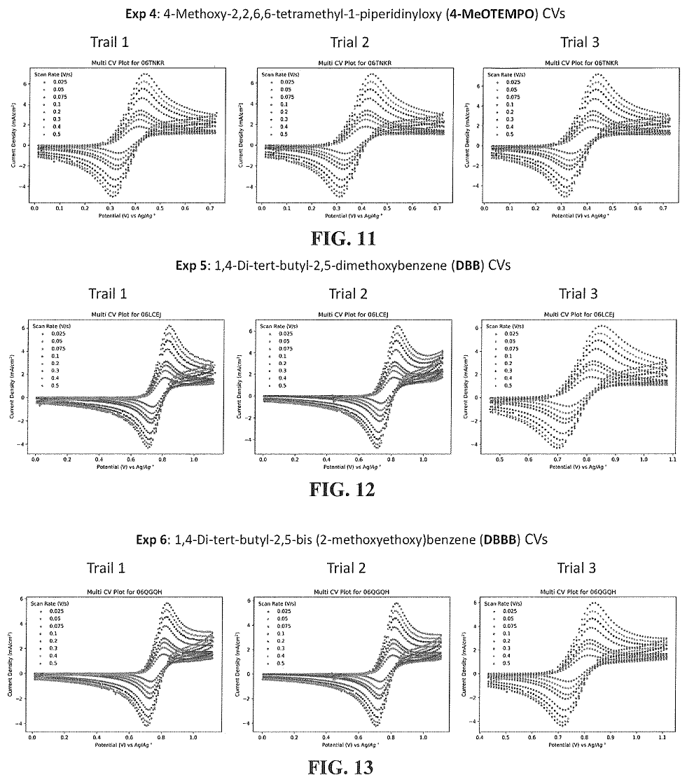

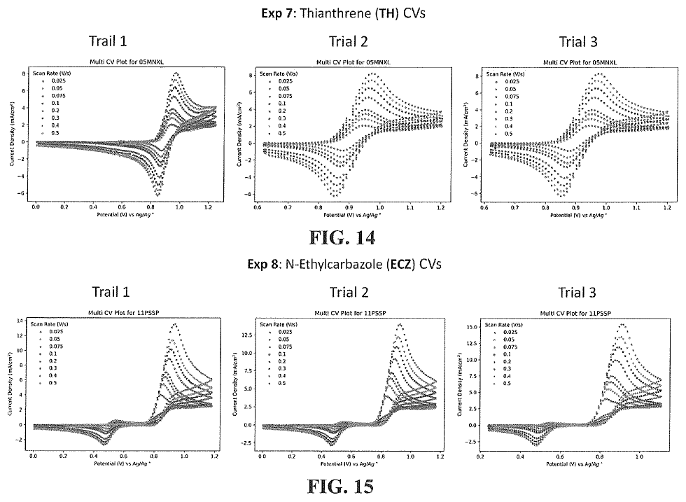

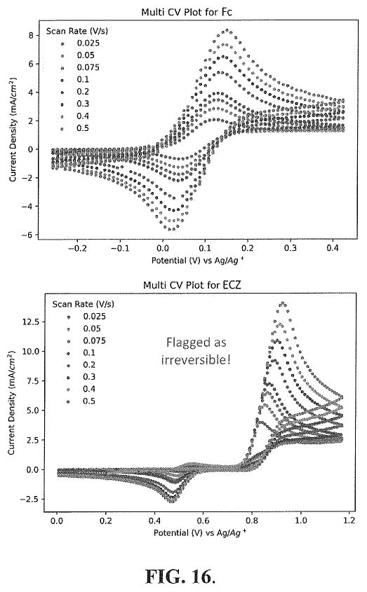

The embedded data processing resulted in CV plots (FIGS. 8-15) and diffusion coefficient (Tables 2-3) data for each system. Notably, the eighth redox active system (ECZ) has a known irreversible first oxidation, and the D³TaLES data processors flagged this system as irreversible (FIG. 16).

TABLE 2
Comparison of values produced during robotic experimentation and literature-reported
diffusion coefficients. The robotics/ExpFlow values relative to Fc/Fc⁺ use the
potential gathered for Fc in the robotic experiments as the standard.

| | | Robotic/ExpFlow | | | | | | Literature | | Literature | |
|---|---|---|---|---|---|---|---|---|---|---|---|
| | | | | | Avg. | | | Reported vs. | | Reported vs. | |
| | | Trial | Trial | Trial | (vs. | Std. | vs. | Ag/Ag+ | | Fc/Fc+ | |
| Exp. | ROM | 1 | 2 | 3 | Ag/Ag⁺) | Dev. | Fc/Fc^{+α} | Value | Ref. | Value | Ref. |
| Exp | Fc | 0.081 | 0.082 | 0.082 | 0.082 | 0.001 | 0.000 | 0.086 | Ref.⁶ | | |
| 1 | | | | | | | | | | | |
| Exp | MEEPT | 0.396 | 0.396 | 0.396 | 0.396 | 0.000 | 0.314 | 0.410* | Ref.¹⁴ | 0.310 | Ref.⁸ |
| 2 | | | | | | | | | | | |
| Exp | DMPZ | −0.156 | −0.156 | −0.156 | −0.156 | 0.000 | −0.238 | −0.150 | Ref.⁹ | | |
| 3 | | | | | | | | | | | |
| Exp | 4- | 0.371 | 0.376 | 0.375 | 0.374 | 0.003 | 0.292 | 0.68⁺⁺ | Ref ⁵ | | |
| 4 | MeOTEMPO | | | | | | | | | | |
| Exp | DBB | 0.773 | 0.773 | 0.773 | 0.773 | 0.000 | 0.691 | 0.710 | Ref.¹⁰ | | |
| 5 | | | | | | | | | | | |
| Exp | DBBB | 0.773 | 0.768 | 0.773 | 0.771 | 0.003 | 0.690 | | | 0.60^{‡} | Ref.¹³ |
| 6 | | | | | | | | | | | |
| Exp | TH | 0.910 | 0.910 | 0.910 | 0.910 | 0.000 | 0.828 | 0.900 | Ref.¹² | 0.840 | Ref.⁷ |
| 7 | | | | | | | | | | | |
| Exp | ECZ** | 0.678 | 0.678 | 0.672 | 0.676 | 0.003 | 0.594 | | | | |
| 8 | | | | | | | | | | | |

^{α}Oxidation potential vs. Fc/Fc⁺ is estimated using the oxidation potential of Fc redox couple obtained from our robotics measurements.
*Literature reported Eₒₓ is for MPT.
⁺⁺Literature reported Eₒₓ is for TEMPO. Consequently, this point is not included.
**The first oxidation of ECZ is irreversible, so no oxidation potential value is reported in the literature. The D³TaLES processing code flagged this as irreversible.
^{‡}Eₒₓ estimated based on E_{cell} potential provided literature.

TABLE 3
Comparison of values produced during robotic experimentation
and literature-reported values for oxidation potential.

| | | Robotic/ ExpFlow | | | | | Literature | |
|---|---|---|---|---|---|---|---|---|
| | | | Trial | | | Std. | Reported | |
| Exp. | ROM | Trial 1 | 2 | Trial 3 | Avg. | Dev. | Value | Ref. |
| Exp1 | Fc | 1.70 | 1.70 | 1.80 | 1.73 | 0.06 | 2.10 | Ref.¹¹ |
| Exp2 | MEEPT | 0.93 | 0.87 | 0.99 | 0.93 | 0.06 | 1.15 | Ref.⁸ |
| Exp3 | DMPZ | 1.50 | 1.30 | 1.50 | 1.43 | 0.12 | 1.58 | Ref.⁹ |
| Exp4 | 4- | 1.20 | 1.10 | 1.30 | 1.20 | 0.10 | 2.60⁺⁺ | Ref.⁵ |
| | MeOTEMPO | | | | | | | |
| Exp5 | DBB | 0.90 | 1.00 | 0.86 | 0.92 | 0.07 | 1.00* | Ref.¹⁰ |
| Exp6 | DBBB | 0.77 | 0.81 | 0.86 | 0.81 | 0.05 | | |
| Exp7 | TH | 1.70 | 1.70 | 1.80 | 1.73 | 0.06 | 2.01 | Ref.⁴ |
| Exp8 | ECZ** | 3.50 | 4.20 | 5.60 | 4.43 | 1.07 | | |

⁺⁺Literature reported diffusion coefficient is for TEMPO. Consequently, this point is not included.
*Diffusion reported 0.77E−05 to 1.23E−05 cm²/s
**The first oxidation of ECZ is irreversible, so no diffusion coefficient value is reported in the literature. The D³TaLES processing code flagged this as irreversible.

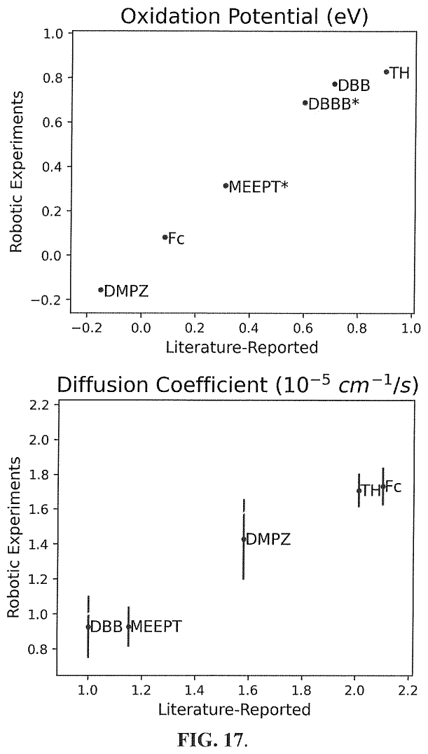

As shown in FIG. 17 (see also Tables 2 and 3 above), the measured and calculated oxidation potentials and diffusion coefficients align very well with literature reported values. The robotic experiment diffusion coefficients also correlate well with the literature reported values, though the experiment values are slightly lower than the literature reported values. These results demonstrate that our robotic experimentation and data processing systems produce reliable results.

In summary, software and hardware that allow experimentalists to systematically encode their laboratory workflow through an intuitive graphical interface are disclosed herein. These encoded workflows standardize experimental practices to capture all experiment metadata and increase reproducibility. Machine-readable ExpFlow procedures also facilitate the translation of human-developed laboratory procedures to robotic experimentation, as we demonstrate for robotic electrochemistry experiments. The examples are directed to data parsing for electrochemistry/CV experiments. However, this should not be taken as limiting as the disclosed software and hardware likewise are readily adaptable to support data parsing for IR, UV-Vis spectroscopy and viscosity measurements. Further contemplated improvements include, without intending any limitation, nitrogen purging the electrochemical cell, iR compensation, and incorporating internal electrochemical reference to improve the quality and breadth of the robotic experiments. For example, nitrogen purging will allow measurements of more extreme redox potentials, beyond where current solutions are sensitive to ambient water and oxygen. Likewise, incorporating iR compensation will produce voltammograms that will allow the effective use of existing charge transfer rate calculators. Liquid dispensers are contemplated for multiple solvent/supporting electrolyte combinations and/or concentrations for high-throughput experimental data collection. Still more, additional characterization metrics such as viscosity, solubility, spectroscopy etc. are contemplated, as well as introduction of autonomous features such as integrated machine learning and robotic camera vision models to determine, for example, if a solute is completely dissolved,¹⁷ autonomous error detection, and dynamic workflows that adapt to live data feedback.

As the skilled artisan will appreciate, the described software and hardware system for exploring properties of molecules is further readily adaptable to autonomous electrochemical experimentation, for example machine learning models for materials optimization and discovery. Examples include machine learning models for analysis of redox electrolytes, autonomous formulation and electrochemical characterization of redox electrolytes for development of improved redox electrolytes and/or characterization of redox electrolytes for determination of suitability/optimization for use in various applications. Still more, the system is readily adaptable to generation of large data sets for training of subsequent machine learning models.

While the terms used herein are believed to be well understood by those of ordinary skill in the art, certain definitions are set forth to facilitate explanation of the presently disclosed subject matter.

Unless defined otherwise, all technical and scientific terms used herein have the same meaning as is commonly understood by one of skill in the art to which the invention(s) belong.

Any and all patents, patent applications, published applications and publications, GenBank sequences, databases, websites and other published materials referred to throughout the entire disclosure herein, unless noted otherwise, are incorporated by reference in their entirety.

Where reference is made to a URL or other such identifier or address, it is understood that such identifiers can change and particular information on the internet can come and go, but equivalent information can be found by searching the internet. Reference thereto evidences the availability and public dissemination of such information.

Although any methods, devices, and materials similar or equivalent to those described herein can be used in the practice or testing of the presently disclosed subject matter, representative methods, devices, and materials are described herein.

The present application can “comprise” (open ended) or “consist essentially of” the components of the present invention as well as other ingredients or elements described herein. As used herein, “comprising” is open ended and means the elements recited, or their equivalent in structure or function, plus any other element or elements which are not recited. The terms “having” and “including” are also to be construed as open ended unless the context suggests otherwise.

Following long-standing patent law convention, the terms “a”, “an”, and “the” refer to “one or more” when used in this application, including the claims. Unless otherwise indicated, all numbers expressing quantities or values are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about” is meant to encompass variations of in some embodiments ±20%, in some embodiments ±10%, in some embodiments ±5%, in some embodiments ±1%, in some embodiments ±0.5%, in some embodiments ±0.1%, in some embodiments ±0.01%, and in some embodiments ±0.001% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, “optional” or “optionally” means that the subsequently described event or circumstance does or does not occur and that the description includes instances where said event or circumstance occurs and instances where it does not. For example, an optionally variant portion means that the portion is variant or non-variant.

All publications, patents, and patent applications mentioned in this specification are herein incorporated by reference to the same extent as if each individual publication, patent, or patent application was specifically and individually indicated to be incorporated by reference.

It will be understood that various details of the presently disclosed subject matter can be changed without departing from the scope of the subject matter disclosed herein. Furthermore, the foregoing description is for the purpose of illustration only, and not for the purpose of limitation. Obvious modifications and variations are possible in light of the above teachings. All such modifications and variations are within the scope of the appended claims when interpreted in accordance with the breadth to which they are fairly, legally and equitably entitled.

### References

(1) Duke, R.; Bhat, V.; Risko, C. Data storage architectures to accelerate chemical discovery: data accessibility for individual laboratories and the community. Chemical Science 2022, 13 (46), 13646-13656. DOI: 10.1039/d2sc05142g (acccessed 2022-11-08T23: 16:28).

(2) Pyzer-Knapp, E. O.; Suh, C.; Gómez-Bombarelli, R.; Aguilera-Iparraguirre, J.; Aspuru-Guzik, A. What Is High-Throughput Virtual Screening? A Perspective from Organic Materials Discovery. Annual Review of Materials Research 2015, 45 (1), 195-216. DOI: 10.1146/annurev-matsci-070214-020823 (acccessed 2023-02-14T15: 28:00).

(3) Gómez-Bombarelli, R.; Aguilera-Iparraguirre, J.; Hirzel, T. D.; Duvenaud, D.; Maclaurin, D.; Blood-Forsythe, M. A.; Chae, H. S.; Einzinger, M.; Ha, D.-G.; Wu, T.; et al. Design of efficient molecular organic light-emitting diodes by a high-throughput virtual screening and experimental approach. Nature Materials 2016, 15 (10), 1120-1127. DOI: 10.1038/nmat4717 (acccessed 2021-09-21T20: 58:56).

(4) Zhang, Q.; Khetan, A.; Sorkun, E.; Niu, F.; Loss, A.; Pucher, I.; Er, S. Data-driven discovery of small electroactive molecules for energy storage in aqueous redox flow batteries. Energy Storage Materials 2022, 47, 167-177. DOI: 10.1016/j.ensm.2022.02.013 (acccessed 2022-04-18T19: 31:22).

(5) Agrawal, A.; Choudhary, A. Perspective: Materials informatics and big data: Realization of the “fourth paradigm” of science in materials science. APL Materials 2016, 4 (5), 053208. DOI: 10.1063/1.4946894 (acccessed 2021-12-07T13: 40:13).

(6) Hood, L.; Rowen, L. The human genome project: big science transforms biology and medicine. Genome Medicine 2013, 5 (9), 79. DOI: 10.1186/gm483 (acccessed 2022-06-28T19: 43:38).

(7) Savage, N. Bioinformatics: Big data versus the big C. Nature 2014, 509 (7502), S66-S67.DOI: 10.1038/509s66a (acccessed 2022-06-28T19: 15:14).

(8) Pollice, R.; Dos Passos Gomes, G.; Aldeghi, M.; Hickman, R. J.; Krenn, M.; Lavigne, C.; Lindner-D′ Addario, M.; Nigam, A.; Ser, C. T.; Yao, Z.; et al. Data-Driven Strategies for Accelerated Materials Design. Accounts of Chemical Research 2021, 54 (4), 849-860. DOI: 10.1021/acs.accounts.0c00785 (acccessed 2021-09-21T20: 54:50).

(9) Seifrid, M.; Pollice, R.; Aguilar-Granda, A.; Morgan Chan, Z.; Hotta, K.; Ser, C. T.; Vestfrid, J.; Wu, T. C.; Aspuru-Guzik, A. Autonomous Chemical Experiments: Challenges and Perspectives on Establishing a Self-Driving Lab. Accounts of Chemical Research 2022, 55 (17), 2454-2466. DOI: 10.1021/acs.accounts.2c00220 (acccessed 2023-03-09T19: 21:48).

(10) Macleod, B. P.; Parlane, F. G. L.; Rupnow, C. C.; Dettelbach, K. E.; Elliott, M. S.; Morrissey, T. D.; Haley, T. H.; Proskurin, O.; Rooney, M. B.; Taherimakhsousi, N.; et al. A self-driving laboratory advances the Pareto front for material properties. Nature Communications 2022, 13 (1). DOI: 10.1038/s41467-022-28580-6 (acccessed 2022-03-09T13: 41:52).

(11) Yano, J.; Gaffney, K. J.; Gregoire, J.; Hung, L.; Ourmazd, A.; Schrier, J.; Sethian, J. A.; Toma, F. M. The case for data science in experimental chemistry: examples and recommendations. Nature Reviews Chemistry 2022, 6 (5), 357-370. DOI: 10.1038/s41570-022-00382-w.

(12) Shimizu, R.; Kobayashi, S.; Watanabe, Y.; Ando, Y.; Hitosugi, T. Autonomous materials synthesis by machine learning and robotics. APL Materials 2020, 8 (11), 111110. DOI: 10.1063/5.0020370 (acccessed 2022-09-02T18: 09:26).

(13) Brandt, N.; Griem, L.; Herrmann, C.; Schoof, E.; Tosato, G.; Zhao, Y.; Zschumme, P.; Selzer, M. Kadi4Mat: A Research Data Infrastructure for Materials Science. Data Science Journal 2021, 20. DOI: 10.5334/dsj-2021-008 (acccessed 2021-12-07T13: 40:15).

(14) Steinbeck, C.; Koepler, O.; Bach, F.; Herres-Pawlis, S.; Jung, N.; Liermann, J.; Neumann, S.; Razum, M.; Baldauf, C.; Biedermann, F.; et al. NFDI4Chem-Towards a National Research Data Infrastructure for Chemistry in Germany. Research Ideas and Outcomes 2020, 6. DOI: 10.3897/rio.6.e55852 (acccessed 2022-07-26T17: 57:45).

(15) Potthoff, J.; Tremouilhac, P.; Hodapp, P.; Neumair, B.; Bräse, S.; Jung, N. Procedures for systematic capture and management of analytical data in academia. Analytica Chimica Acta: X 2019, 1, 100007. DOI: https://doi.org/10.1016/acax 2019 100007.

(16) Beaucage, P. A.; Martin, T. B. The Autonomous Formulation Laboratory: An Open Liquid Handling Platform for Formulation Discovery Using X-ray and Neutron Scattering. Chemistry of Materials 2023, 35 (3), 846-852. DOI: 10.1021/acs.chemmater.2c03118 (acccessed 2023-01-25T17: 00:30).

(17) Shiri, P.; Lai, V.; Zepel, T.; Griffin, D.; Reifman, J.; Clark, S.; Grunert, S.; Yunker, L. P. E.; Steiner, S.; Situ, H.; et al. Automated solubility screening platform using computer vision. iScience 2021, 24 (3), 102176. DOI: 10.1016/j.isci.2021.102176 (acccessed 2022-11-11T18: 44:57).

(18) Zhang, B.; Merker, L.; Sanin, A.; Stein, H. S. Robotic cell assembly to accelerate battery research. Digital Discovery 2022. DOI: 10.1039/d2dd00046f (acccessed 2022-10-13T14: 58:11).

(19) Abd El-Hady, M. N.; Gomaa, E. A.; Al-Harazie, A. G. Cyclic voltammetry of bulk and nano CdC12 with ceftazidime drug and some DFT calculations. Journal of Molecular Liquids 2019, 276, 970-985. DOI: https://doi.org/10. 1016/molliq 2018.10.125.

(20) Mekassa, B.; Tessema, M.; Chandravanshi, B. S.; Baker, P. G. L.; Muya, F. N. Sensitive electrochemical determination of epinephrine at poly (L-aspartic acid)/electro-chemically reduced graphene oxide modified electrode by square wave voltammetry in pharmaceutics. Journal of Electroanalytical Chemistry 2017, 807, 145-153. DOI: https://doi.org/10.1016/j.jelechem.2017.11.045.

(21) Nechaeva, D.; Shishov, A.; Ermakov, S.; Bulatov, A. A paper-based analytical device for the determination of hydrogen sulfide in fuel oils based on headspace liquid-phase microextraction and cyclic voltammetry. Talanta 2018, 183, 290-296. DOI: https://doi.org/10 1016 a.2018 02.074.

(22) Li, M.; Odom, S. A.; Pancoast, A. R.; Robertson, L. A.; Vaid, T. P.; Agarwal, G.; Doan, H. A.; Wang, Y.; Suduwella, T. M.; Bheemireddy, S. R.; et al. Experimental Protocols for Studying Organic Non-aqueous Redox Flow Batteries. ACS Energy Letters 2021, 3932-3943. DOI: 10.1021/acsenergylett. 1c01675 (acccessed 2021-10-21T17: 08:11).

(23) Wedege, K.; Bae, D.; Smith, W. A.; Mendes, A.; Bentien, A. Solar Redox Flow Batteries with Organic Redox Couples in Aqueous Electrolytes: A Minireview. The Journal of Physical Chemistry C 2018, 122 (45), 25729-25740. DOI: 10.1021/acs.jpcc.8b04914 (acccessed 2021-06-07T15: 53:51).

(24) Jittiarporn, P.; Lek, S.; Kooptarnond, K.; Taweepreda, W.; Chooto, P.; Khangkhamano, M. Synthesis of h-MoO3 and (NH4) 2Mo4O13 Using Precipitation Method at Various pH Values and their Photochromic Properties. Applied Mechanics and Materials 2016, 835, 34-41. DOI: 10.4028/www.scientific.net/AMM.835.34.

(25) Rakhshan Pouri, S.; Manic, M.; Phongikaroon, S. A novel framework for intelligent signal detection via artificial neural networks for cyclic voltammetry in pyroprocessing technology. Annals of Nuclear Energy 2018, 111, 242-254. DOI: https://doi.org/10.1016/j.anucene.2017.09.002.

(26) Massah, J.; Asefpour Vakilian, K. An intelligent portable biosensor for fast and accurate nitrate determination using cyclic voltammetry. Biosystems Engineering 2019, 177, 49-58. DOI: https://doi.org/10. 1016/1 biosystemseng 2018 09 007.

(27) Django Software Foundation. Django 2.2. 2019. https://djangoproject.com.

(28) MongoDB. https://www mongodb com/(accessed June 25 2022).

(29) Duke, R.; Bhat, V.; Sornberger, P.; Odom, S. A.; Risko, C. A comprehensive data infrastructure for redox-active organic molecules. Digital Discovery. Submitted. 2023.

(30) Bard, A. J.; Faulkner, L. R. Electrochemical methods, fundamental and applications, John Wiley & Sons. N Y 2001, 99.

(31) KINOVA KORTEX API. https://github.comKinovarobotics/kortex/.

(32) Jain, A.; Ong, S. P.; Chen, W.; Medasani, B.; Qu, X.; Kocher, M.; Brafman, M.; Petretto, G.; Rignanese, G. M.; Hautier, G.; et al. FireWorks: a dynamic workflow system designed for high-throughput applications. Concurrency and Computation: Practice and Experience 2015, 27 (17), 5037-5059. DOI: 10.1002/cpe.3505 (acccessed 2022-07-19T19: 54:13).

(33) Kinova. https://www.kinovarobotics com/

(34) BioLogic. https://www biologic net/.

(35) Elgrishi, N.; Rountree, K. J.; Mccarthy, B. D.; Rountree, E. S.; Eisenhart, T. T.; Dempsey, J. L. A Practical Beginner's Guide to Cyclic Voltammetry. Journal of Chemical Education 2018, 95 (2), 197-206. DOI: 10.1021/acs.jchemed. 7b00361 (acccessed 2021-09-02T14: 23:21).

(36) Moshurchak, L. M.; Lamanna, W. M.; Bulinski, M.; Wang, R. L.; Garsuch, R. R.; Jiang, J.; Magnuson, D.; Triemert, M.; Dahn, J. R. High-Potential Redox Shuttle for Use in Lithium-Ion Batteries. Journal of The Electrochemical Society 2009, 156 (4), A309. DOI: 10.1149/1.3077578.

(37) Huo, Y.; Xing, X.; Zhang, C.; Wang, X.; Li, Y. An all organic redox flow battery with high cell voltage. RSC Advances 2019, 9 (23), 13128-13132. DOI: 10.1039/c9ra01514k (acccessed 2023-05-30T20: 24:31).

(38) Zhang, L.; Zhang, Z.; Redfern, P. C.; Curtiss, L. A.; Amine, K. Molecular engineering towards safer lithium-ion batteries: a highly stable and compatible redox shuttle for overcharge protection. Energy & Environmental Science 2012, 5 (8), 8204-8207, 10.1039/C2EE21977H. DOI: 10.1039/C2EE21977H.

(39) Etkind, S. I.; Lopez, J.; Zhu, Y. G.; Fang, J.-H.; Ong, W. J.; Shao-Horn, Y.; Swager, T. M. Thianthrene-Based Bipolar Redox-Active Molecules Toward Symmetric All-Organic Batteries. ACS Sustainable Chemistry & Engineering 2022, 10 (36), 11739-11750. DOI: 10.1021/acssuschemeng.2c01717.

(40) Ergun, S.; Elliott, C. F.; Kaur, A. P.; Parkin, S. R.; Odom, S. A. Controlling Oxidation Potentials in Redox Shuttle Candidates for Lithium-Ion Batteries. The Journal of Physical Chemistry C 2014, 118 (27), 14824-14832. DOI: 10.1021/jp503767h.

(41) Kwon, G.; Lee, K.; Lee, M. H.; Lee, B.; Lee, S.; Jung, S.-K.; Ku, K.; Kim, J.; Park, S. Y.; Kwon, J. E.; et al. Bio-inspired Molecular Redesign of a Multi-redox Catholyte for High-Energy Non-aqueous Organic Redox Flow Batteries. Chem 2019, 5 (10), 2642-2656. DOI: 10.1016/j.chempr.2019.07.006 (acccessed 2023-06-13T20: 13:29).

(42) Liang, Z.; Attanayake, N. H.; Greco, K. V.; Neyhouse, B. J.; Barton, J. L.; Kaur, A. P.; Eubanks, W. L.; Brushett, F. R.; Landon, J.; Odom, S. A. Comparison of Separators vs Membranes in Nonaqueous Redox Flow Battery Electrolytes Containing Small Molecule Active Materials. ACS Applied Energy Materials 2021, 4 (6), 5443-5451. DOI: 10.1021/acsaem.1c00017 (acccessed 2023-02-10T20: 33:38).

(43) Armstrong, C. G.; Hogue, R. W.; Toghill, K. E. Characterisation of the ferrocene/ferrocenium ion redox couple as a model chemistry for non-aqueous redox flow battery research. Journal of Electroanalytical Chemistry 2020, 872, 114241. DOI: 10.1016/j.jelechem.2020.114241 (acccessed 2023-03-22T17: 39:50).

(44) Milshtein, J. D.; Kaur, A. P.; Casselman, M. D.; Kowalski, J. A.; Modekrutti, S.; Zhang, P. L.; Harsha Attanayake, N.; Elliott, C. F.; Parkin, S. R.; Risko, C.; et al. High current density, long duration cycling of soluble organic active species for non-aqueous redox flow batteries. Energy & Environmental Science 2016, 9 (11), 3531-3543. DOI: 10.1039/c6ee02027e (acccessed 2023-02-10T20: 32:23).

(45) Kwon, G.; Lee, S.; Hwang, J.; Shim, H.-S.; Lee, B.; Lee, M. H.; Ko, Y.; Jung, S.-K.; Ku, K.; Hong, J.; et al. Multi-redox Molecule for High-Energy Redox Flow Batteries. Joule 2018, 2 (9), 1771-1782. DOI: 10.1016/j.joule.2018.05.014 (acccessed 2023-06-05T16:57:43).

(46) Nihon, K. Electron-Transfer Kinetics of Nitroxide Radicals as an Electrode-Active Material. Bulletin of the Chemical Society of Japan. 2004, 77 (12), 2203-2204. DOI: 10.1246/bcsj.77.2203.

(47) Peerce, P. J.; Bard, A. J. Polymer films on electrodes: Part II. Film structure and mechanism of electron transfer with electrodeposited poly (vinylferrocene). Journal of Electroanalytical Chemistry and Interfacial Electrochemistry 1980, 112 (1), 97-115. DOI: https://doi.org/10 1016/S0022-0728 (80) 80011-8.

(48) Wang, Y.; Rogers, E. I.; Compton, R. G. The measurement of the diffusion coefficients of ferrocene and ferrocenium and their temperature dependence in acetonitrile using double potential step microdisk electrode chronoamperometry. Journal of Electroanalytical Chemistry 2010, 648 (1), 15-19. DOI: https://doi.org/10 10164 jelechem 2010 07.006.

(49) Tegegne, B. G.; Kabtamu, D. M.; Li, Y.-Z.; Ou, Y.-T.; Huang, Z.-J.; Hsu, N.-Y.; Ku, H.-H.; Wang, Y.-M.; Wang, C.-H. N-methylphenothiazine as stable and low-cost catholyte for nonaqueous organic redox flow battery. Journal of Energy Storage 2023, 61, 106753. DOI: https://doi.org/10 10164 est 2023.106753.

(50) De La Garza, G. D.; Kaur, A. P.; Shkrob, I. A.; Robertson, L. A.; Odom, S. A.; Mcneil, A. J. Soluble and stable symmetric tetrazines as anolytes in redox flow batteries. Journal of Materials Chemistry A 2022, 10 (36), 18745-18752. DOI: 10.1039/d2ta04515j (acccessed 2023-06-05T17: 12:49).

(51) Kim, J.; Kim, H.; Lee, S.; Kwon, G.; Kang, T.; Park, H.; Tamwattana, O.; Ko, Y.; Lee, D.; Kang, K. A p-n fusion strategy to design bipolar organic materials for high-energy-density symmetric batteries. Journal of Materials Chemistry A 2021, 9 (25), 14485-14494. DOI: 10.1039/dlta02059e (acccessed 2023-06-05T17: 07:34).

(52) Speer, M. E.; Kolek, M.; Jassoy, J. J.; Heine, J.; Winter, M.; Bieker, P. M.; Esser, B. Thianthrene-functionalized polynorbornenes as high-voltage materials for organic cathode-based dual-ion batteries. Chemical Communications 2015, 51 (83), 15261-15264. DOI: 10.1039/c5cc04932f (acccessed 2023-06-05T17: 11:50).

(53) Minteer, S.; Chen, J.; Lin, S.; Crudden, C.; Dehnen, S.; Kamat, P. V.; Kozlowski, M.; Masson, G.; Miller, S. J. New Guidelines for Presenting Electrochemical Data in All ACS Journals. ACS Catalysis 2023, 13 (7), 4468-4469. DOI: 10.1021/acscatal.3c00995 (acccessed 2023-06-09T12: 15:06).

(54) Cao, B.; Adutwum, L. A.; Oliynyk, A. O.; Luber, E. J.; Olsen, B. C.; Mar, A.; Buriak, J. M. How To Optimize Materials and Devices via Design of Experiments and Machine Learning: Demonstration Using Organic Photovoltaics. ACS Nano 2018, 12 (8), 7434-7444. DOI: 10.1021/acsnano.8b04726 (accessed 2022-02-01T16: 06:17).

What is claimed:

1. A system comprising a processor, memory, storage, and computer-readable instructions and configured for performing automated electrochemical experimentation and for analyzing data generated by said electrochemical experimentation, comprising:
a Template module configured for receiving a one or more experimental inputs representing experimental parameters for one or more electrochemical experiments;
an Experiment module configured for:
selecting one or more experimental inputs from the plurality of experimental inputs to define at least one specific electrochemical experiment to be conducted and a number of experimental runs of the at least one specific electrochemical experiment; and
recording data generated by the at least one specific electrochemical experiment;
a Run module configured for outputting the one or more experimental inputs to a robotics computing device comprising a processor, memory, and storage;
a data parser configured to extract data from the recorded data and metadata from the defined at least one specific electrochemical experiment; and
a robotic assembly adapted for performing the specific electrochemical experiment.

2. The system of claim 1, wherein the one or more experimental inputs are selected from the group consisting of reagent types, apparatus items, and workflow actions.

3. The system of claim 2, wherein the reagent types are selected from the group consisting of redox molecules, solvents, and electrolyte solutions.

4. The system of claim 2, wherein the apparatus items are selected from the group consisting of glassware, plasticware, a working electrode, a reference electrode, an electrode counter, and an electrochemical cell.

5. The system of claim 2, wherein the workflow actions are selected from the group consisting of liquid transfer actions, solid transfer actions, heating actions, stirring actions, measurements of the working electrode surface area, and data collection actions.

6. The system of claim 1, wherein the recorded data are selected from the group consisting of experiment times, reagent weights, temperatures, and raw data resulting from the at least one specific electrochemical experiment.

7. The system of claim 1, wherein the robotic assembly comprises:
a robotic arm adapted for grasping and translating a vial;
a grid vial stand;
a vial elevator adapted to translate one or more vials in a substantially vertical direction;
a potentiostat; and
a computing device comprising a processor, memory, storage, and an interface to the robotic arm, further comprising computer-readable instructions for transferring the one or more experimental inputs from the plurality of experimental inputs to define the at least one specific electrochemical experiment.

8. In a computing environment, a computer-implemented method for performing automated electrochemical experimentation and for analyzing data generated by said electrochemical experimentation, comprising:
providing a Template module configured for receiving a one or more experimental inputs representing experimental parameters for one or more electrochemical experiments;
providing an Experiment module configured for:
selecting one or more experimental inputs from the plurality of experimental inputs to define at least one specific electrochemical experiment to be conducted and a number of experimental runs of the at least one specific electrochemical experiment; and
recording data generated by the at least one specific electrochemical experiment;
providing a Run module configured for outputting the one or more experimental inputs to a robotics computing device comprising a processor, memory, and storage;
providing a data parser configured to extract data from the recorded data and metadata from the defined at least one specific electrochemical experiment; and
providing a robotic assembly adapted for performing the specific electrochemical experiment, the robotic assembly comprising a computing device comprising a processor, memory, storage, and an interface to the robotic arm, further comprising computer-readable instructions for transferring the one or more experimental inputs from the plurality of experimental inputs to define the at least one specific electrochemical experiment.

9. The computer-implemented method of claim 8, including selecting the experimental inputs from the group consisting of reagent types, apparatus items, and workflow actions.

10. The computer-implemented method of claim 9, including selecting the reagent types from the group consisting of redox molecules, solvents, and electrolyte solutions.

11. The computer-implemented method of claim 9, including selecting the apparatus items from the group consisting of glassware, plasticware, a working electrode, a reference electrode, an electrode counter, and an electrochemical cell.

12. The computer-implemented method of claim 9, including selecting the workflow actions from the group consisting of liquid transfer actions, solid transfer actions, heating actions, stirring actions, measurements of the working electrode surface area, and data collection actions.

13. The computer-implemented method of claim 8, including selecting the recorded data from the group consisting of experiment times, reagent weights, temperatures, and raw data resulting from the at least one specific electrochemical experiment.
